(19) United States
(12) Patent Application Publication
(10) Pub. No.: US 2021/0395851 A1
(43) Pub. Date: Dec. 23, 2021

(54) COATED GRAIN ORIENTED ELECTRICAL STEEL PLATES, AND METHODS OF PRODUCING THE SAME

(71) Applicant: AXALTA COATING SYSTEMS IP CO., LLC, Wilmington, DE (US)

(72) Inventors: Dirk Bentz, Wuppertal (DE); Christoph Lomoschitz, Laxenburg (AT); Andreas Vendler, Traiskirchen (AT)

(73) Assignee: AXALTA COATING SYSTEMS IP CO., LLC, Wilmington, PA (US)

(21) Appl. No.: 16/903,675

(22) Filed: Jun. 17, 2020

(51) Int. Cl. C21D 9/46; C22C 38/02; C22C 33/04; C21D 8/12; C21D 8/00; C21D 6/00; C21D 3/04; B05D 7/14; B05D 3/06; H01F 1/147

(52) U.S. Cl. CPC C21D 9/46; C22C 38/02; C22C 33/04; C21D 8/1233; C21D 8/1272; C22C 2202/02; C21D 6/008; C21D 3/04; B05D 7/14; B05D 3/06; H01F 1/147; C21D 8/005

(57) ABSTRACT

Coated grain oriented electrical steel plates and methods of producing the same are provided. In an exemplary embodiment, a method includes producing molten steel with from about 2.5 to about 4 weight percent silicon, from about 0.005 to about 0.1 weight percent carbon, and from about 90 to about 97.5 weight percent iron. The molten steel is cast into a slab and then cold rolled into a plate having a surface. The plate is decarbonized using a decarbonization anneal, and then recrystallized using a recrystallization anneal to produce grain oriented electrical steel. A coating is applied overlying the surface, where the coating includes an organic radiation curable crosslinking agent and a photo-initiator. The coating is cured by exposing it to a radiation source.

### TECHNICAL FIELD

The present disclosure generally relates to grain oriented electrical steel plates with coatings, and methods of producing the same, and more particularly relates to grain oriented electrical steel plates with coatings having organic components, and methods of producing the same.

### BACKGROUND

Electrical steel has specific desirable magnetic properties, such as a low magnetic hysteresis, high magnetic flux density, superior core loss and high magnetic permeability. Electrical steel is typically used for motors, transformers, and other electrical components, where the desirable magnetic properties result in lower energy losses during use. Electrical steel is generally provided in thin sheets or plates, and several of these plates are stacked together to form the desired structure. Each plate typically has an insulating coating to provide insulating properties, and the coating displays good coating properties such as adhesion, strength, protection from corrosion, etc.

Grain oriented electrical steel is produced with anisotropic properties, so the grain oriented electrical steel sheet has different properties in one direction as compared to another direction. As such, the magnetic permeability, magnetic flux density, and other properties can be maximized in a desired direction, and this is particularly beneficial for electrical transformers where orientation of the steel sheet remains constant within the transformer. Grain oriented electrical steel has oriented crystals that favor the magnetic properties in a rolling direction. However, the crystals are oriented in a recrystallization annealing process with temperatures that are high enough to decompose organic components. Therefore, the insulating coatings for grain oriented electrical steel are non-organic, and many include chromium compounds, such as chromic anhydrides, chromates, or dichromates. The chromium compounds provide favorable moisture-absorption resistance for the insulation coating, but result in treatment solutions that include hexachromium, which has adverse environmental effects. The inorganic coatings are brittle with limited flexibility, and tend to flake and form dust, particularly during cutting, punching, and stamping operations.

Accordingly, it is desirable to provide a grain oriented electrical steel with an insulating coating that includes organics, and methods of producing the same. In addition, it is desirable to provide a grain oriented electrical steel and methods for producing such steel with an insulating coating that remains adhered and protective after cutting, punching, or stamping operations, where the coating provides good protection from corrosion and moisture. Furthermore, other desirable features and characteristics of the present embodiment will become apparent from the subsequent detailed description and the appended claims, taken in conjunction with the accompanying drawing and this background.

### BRIEF SUMMARY

Coated grain oriented electrical steel plates and methods of producing the same are provided. In an exemplary embodiment, a method includes producing molten steel with from about 2.5 to about 4 weight percent silicon, from about 0.005 to about 0.1 weight percent carbon, and from about 90 to about 97.5 weight percent iron. The molten steel is cast into a slab and then cold rolled into a plate having a surface. The plate is decarbonized using a decarbonization anneal, and then recrystallized using a recrystallization anneal to produce grain oriented electrical steel. A coating is applied overlying the surface, where the coating includes a photo-initiator and a radiation curable crosslinking agent that is organic. The coating is cured by exposing it to a radiation source.

A method of producing a grain oriented electrical steel is provided in another method. The method includes producing a plate of electrical steel, and recrystallizing the plate in a recrystallization anneal to produce the grain oriented electrical steel. The plate is recrystallized on a production line that includes transfer rollers. A coating is applied to a surface of the plate while the plate in on the production line, where the coating includes organic components. The coating is cured on the surface of the plate by exposing the coating to a radiation source, where the plate is cured while on the production line.

A grain oriented electrical steel plate is provided in another embodiment. The steel plate has a surface with a forsterite layer at the surface. A coating overlies the surface, where the coating includes organic components at from about 10 to about 99 weight percent. The organic components include polymers formed from radiation curable crosslinking agents. The steel includes carbon at from about 0.01 to about 0.03 weight percent, and silicon at from about 2.5 to about 4.0 weight percent. The plate is a grain oriented electrical steel with anisotropic magnetic properties, where a plate magnetic permeability in a roll direction is greater than the plate magnetic permeability in a cross direction that is perpendicular to the roll direction.

### BRIEF DESCRIPTION OF THE DRAWINGS

The present embodiments will hereinafter be described in conjunction with the following drawing figures, wherein like numerals denote like elements, and wherein:

FIG. 1 is a flowchart illustrating steps of a method for producing a coated grain oriented electrical steel plate in accordance with an exemplary embodiment;

FIG. 2 is a perspective sectional view of a grain oriented electrical steel plate in accordance with an exemplary embodiment; and

FIG. 3 is a schematic diagram illustrating part of a production line for producing coated grain oriented electrical steel in accordance with an exemplary embodiment.

### DETAILED DESCRIPTION

The following detailed description is merely exemplary in nature and is not intended to limit the application or uses of the embodiments described. Furthermore, there is no intention to be bound by any theory presented in the preceding technical field, background, brief summary, or the following detailed description.

Grain oriented electrical steel requires a high temperature recrystallization anneal to grow crystals in a desired orientation, and this high temperature anneal decomposes organic components that may be present in a coating. However, it is desirable to coat the grain oriented electrical steel with organics, because organic coatings provide superior corrosion resistance, moisture resistance, and processing ability (such as remaining intact and adhered to the plate during cutting, stamping, or punching steps), as compared to a coating that does not include organic components. It is not desirable to introduce a lengthy thermal cure process into the grain oriented electrical steel manufacturing process.

To overcome these limitations, in an exemplary embodiment, a method of producing grain orientated electrical steel is provided in which a coating with organic components is applied after the recrystallization anneal, where the coating includes organic radiation curable crosslinking agents and a photo-initiator. In this regard, the grain oriented electrical steel manufacturing process is modified so that the coating is applied to a surface of the steel, and then irradiated for rapid curing. This produces a grain oriented electrical steel with a coating that includes organic components.

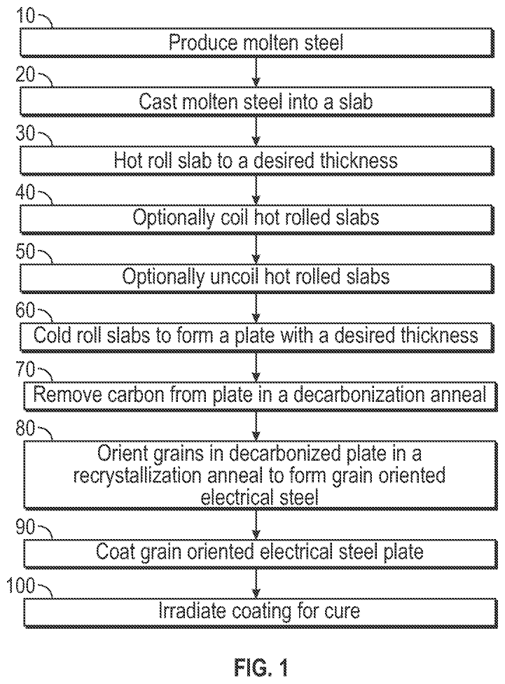

Referring to FIG. 1, in an exemplary embodiment, a method for producing grain oriented electrical steel includes several processes. The method begins by producing molten steel 10 with the desired composition. In an exemplary embodiment, the molten steel includes the element silicon in an amount of from about 2.5 to about 4.0 weight percent, based on a total weight of the molten steel. The molten steel further includes carbon in an amount of from about 0.005 to about 0.1 weight percent, also based on the total weight of the molten steel. Several elements may optionally be included in the molten steel, including: aluminum in an amount of from about 250 to about 450 parts per million by weight (ppm) (i.e., about 0.025 to about 0.045 weight percent, based on a total weight of the molten steel); copper in an amount of from about 300 to about 500 ppm; tin in an amount of from about 500 to about 1,500 ppm; nitrogen in an amount of from 0 to about 150 ppm; manganese in an amount of from 0 to about 1,500 ppm; sulfur in an amount of from about 0 to about 600 ppm; phosphorous in an amount of from 0 to about 1,000 ppm; as well as other impurities in an amount of from 0 to about 2,000 ppm. The molten steel also includes iron in an amount of from about 90 to about 97.5 weight percent, based on the total weight of the molten steel.

The molten steel is cast into a slab 20 for further processing. The slab may go through an intermediate heating process at from about 1,200 to about 1,320 degrees Celsius (° C.) in some embodiments, and then the slab is cooled to below the melting point of the steel. The slab is then hot rolled to a desired thickness 30, and the hot rolled slab may optionally be coiled 40. If the hot rolled slab is coiled, it may be coiled at a temperature of from about 550° C. to about 700° C., but other temperatures are also possible. The hot rolled, optionally coiled slab may be stored or moved in the coiled form. If the hot rolled slab was coiled, the hot rolled slab may then be uncoiled 50 for further processing.

The slab is then cold rolled to form a plate with a desired thickness 60. The desired thickness may be from about 0.1 to about 0.6 millimeters in an exemplary embodiment, but other thicknesses are also possible. The plate may then be annealed in a decarbonization anneal to remove carbon from the plate 70. The decarbonization anneal may be at a temperature of from about 850° C. to about 1,050° C. for from about 20 to about 150 seconds in a wet nitrogen and hydrogen atmosphere, and this may be followed by a nitride anneal in another wet nitrogen and hydrogen atmosphere with ammonia at a temperature of from about 900° C. to about 1,050° C. Decarbonization may include additional anneals at other temperatures or time limits in some embodiments. After the decarbonization anneal, the plate may include carbon at from about 100 to about 300 ppm (i.e., about 0.01 to about 0.03 weight percent, based on a total weight of the plate). The plate may optionally also include aluminum at from about 300 to about 350 ppm, and nitrogen at from about 60 to about 90 ppm. Decarbonization of the plate may help reduce or minimize magnetic aging of the plate.

After the plate is decarbonized, it is recrystallized in a recrystallization anneal 80 to orient the grains and to form a grain oriented electrical steel plate. The recrystallization anneal is performed at a temperature of from about 700 to about 1,300° C. in an exemplary embodiment, and the recrystallization anneal may include several separate anneals at different temperatures and for specific time periods. Correct orientation of the grains in the plate is obtained during the recrystallization anneal, in which the growth of the crystals having the desired orientation is more rapid than grains with different orientations. Not to be bound by theory, but it is theorized that the grain growth process is activated by heat, and certain crystals are more “energized” than others for kinetic or energetic reasons. The faster growing crystals, which tend to have the desired orientation, start growing at the expense of the adjacent crystals, and at a temperature lower than the temperature at which the crystals which originally had the undesired orientation are activated. This facilitates the crystals with the desired orientation reaching a critical size such that they dominate the crystal growth process. The grain oriented electrical steel production process may include one, two, or more heating cycles at high temperatures, all of which are referred to herein as the recrystallization anneal. The exact temperatures, timing, and atmospheres during the one or more heating cycles of the recrystallization anneal may depend on the thickness of the plate, the composition of the plate, and/or other factors. This recrystallization anneal may produce a forsterite layer on the surface of the steel.

The plate may be coated or further processed in some embodiments (not illustrated), and the general processes outlined above may be modified in alternate embodiments. Coatings that may optionally be applied before, after, or in between recrystallization anneals. Inorganic coatings include a wide variety of materials, including but not limited to silica and chromium (VI). These inorganic coatings, combined with the forsterite layer, can provide protection, such as electrical insulation, corrosion resistance, and durability in humid environments. Also, the inorganic layer and the forsterite layer may provide tensile stresses that aid in the performance of the grain oriented electrical steel. However, the inorganic layer may include toxic chemicals, such as chromium (VI), and may have disadvantages like brittleness that result in dust and flakes.

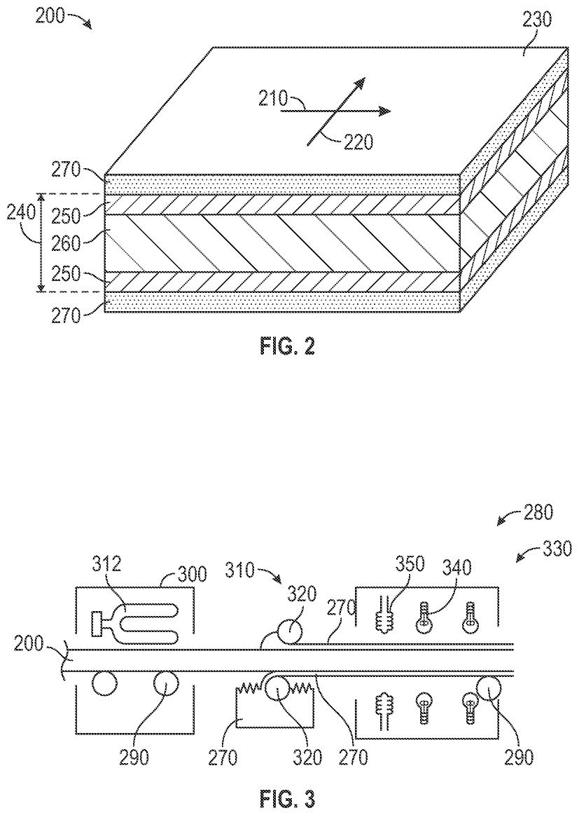

Reference is now made to FIG. 2, with continuing reference to FIG. 1. The plate 200, which is formed of a grain oriented electrical steel, has anisotropic magnetic properties such that magnetic properties are different in one direction, the “roll direction 210,” than in another cross direction 220, where the cross direction 220 is perpendicular to the roll direction 210. The roll direction 210 is the direction in which the slab was cold rolled to form the plate 200. The roll direction 210 and the cross direction 220 are both along a surface 230 of the plate 200, and a thickness 240 of the plate 200 is perpendicular to the surface 230 of the plate 200. The thickness 240 is measured along the smallest dimension of the plate 200. The magnetic properties are generally more favorable in the roll direction 210 than in the cross direction 220 for use in transformers. For example, a plate magnetic permeability in the roll direction 210 is higher than in the cross direction. In an exemplary embodiment, the plate magnetic permeability is about 20 percent or more higher than the plate magnetic permeability in the cross direction 220. In alternate embodiments, the plate magnetic permeability in the roll direction 210 may be about 30 percent or more, or 50 percent or more, higher than the plate magnetic permeability in the cross direction 220.

During the recrystallization anneal a texture may arise through the selective grain growth, and a forsterite layer 250 may form over a body 260 of the plate 200, where the forsterite layer 250 is on the surface 230 of the plate 200. The forsterite layer 250 is sometimes referred to as a “glass film,” but the forsterite layer 250 is not composed of glass. The forsterite layer 250 includes magnesium silicate.

Referring again to FIG. 1, the surface 230 of the grain oriented electrical steel plate 200 is coated 90 with a coating 270, where the coating 270 is illustrated in FIG. 2. The coating 270 may be applied by spraying, rolling, dipping, brushing, or any other suitable application technique. The coating 270 may be applied to one surface 230 of the plate 200, or two or more different surfaces 230 in various embodiments. In the illustration in FIG. 2, the coating 270 is shown overlying a top and bottom surface 230 of the plate 200, but not overlying a side surface 230 of the plate 200, but any other combination of surfaces 230 may be coated in various embodiments. The coating 270 may be applied such that the cured coating 270 has a thickness of from about 1 to about 50 micrometers.

The coating 270 includes organic components and may optionally include inorganic components as well. The components of the coating 270 listed and described herein refer to the coating 270 as applied to the plate 200 and before curing, unless otherwise specified. It is understood that chemical reactions occur during the curing process, so some of the components may react or evaporate during the cure such that the component or concentration is no longer the same as before the cure. The coating 270 after curing includes organic components in an amount of from about 10 to about 99 weight percent, based on a total weight of the cured coating 270, where the organic components include polymers formed from radiation curable crosslinking agents.

The coating 270 (before curing, as mentioned above) includes at least one radiation curable crosslinking agent, where the radiation curable crosslinking agent is organic. The radiation curable crosslinking agent has at least one reactive polymerizable moiety, such as unsaturated double bonds. The radiation curable crosslinking agent(s) may be selected from the group of epoxy compounds, isocyanate compounds, polyurethane compounds, acrylic compounds, polyamide compounds, polyester compounds, silicone compounds, alkenes, and combinations thereof. However, in alternate embodiments other types of radiation curable crosslinking agents may be utilized. The coating 270 may include the radiation curable crosslinking agent in an amount of from about 10 to about 90 weight percent, based on a total weight of the coating.

The radiation curable crosslinking agent may include one component, but in some embodiments two or more components are present. For example, one type of radiation curable crosslinking agent may be a resin, and the resin may be used in conjunction with a reactive diluent. The resin tends to increase the viscosity of the coating 270, and the reactive diluent decreases the viscosity, so the two are balanced to provide a coating with a desirable viscosity. Reaction rates, polymer strength, and many other factors are also balanced and set by the selection of radiation curable crosslinking agents. Usable reactive diluents (which are radiation curable crosslinking agents) are compounds having one or more unsaturated structures which are radically polymerizable. Examples of reactive diluents include, but are not limited to, styrene, vinyl toluene, p-methyl styrene, tert-butyl styrene, divinyl benzene, N-vinyl pyrrolidone, hydroxybutyl vinyl ether, butane diol vinyl ether, triethylene glycol divinyl ether, phthalic acid diallyl ester, fumaric acid diallyl ester, triallyl phosphate, triallyl isocyanurate, diallyl benzene, diallyl bisphenol A, pentaerythritol and tetra allyl ether. Other potential reactive diluents which may optionally be present include acrylic or methacrylic acid esters like hydroxyethyl (meth)acrylate, hydroxypropyl (meth)acrylate, phenoxyethyl (meth) acrylate, dicyclopentadiene (meth)acrylate, butane diol di(meth)acrylate, hexane diol di(meth)acrylate, dipropylene glycol di(meth)acrylate, trimethylol propane di- and tri(meth)acrylate, pentaerythritol di- and tri(meth)acrylate, epoxy resin (meth)acrylates, (meth)acrylates of reaction products of a polyaddition of ethylene or propylene oxide with polyols such as trimethylol propane or pentaerythritol and (meth)acrylates of oligo(ethylene glycol) or oligo(propylene glycol.)

The coating 270 also includes at least one photo-initiator. A wide variety of photo-initiators may be used, including but not limited to benzoins, benzophenones, dialkoxy-benzophenones, 4,4′-bis(dimethylamino)benzophenone (Michler's ketone) and diethoxyacetophenone, but other photo-initiators may be used in alternate embodiments. The photo-initiator should be capable of initiating crosslinking of the radiation curable crosslinking agent. The coating 270 may include the photo-initiator in an amount of from about 0.1 to about 20 weight percent, based on the total weight of the coating.

Silicon compounds are an optional component of the coating 270. The silicon compound may improve adhesion of the coating 270 to the plate 200, and the silicon compound may be present in the coating 270 in an amount of from about 0 to about 50 weight percent, based on the total weight of the coating 270, but the silicon compound may be present in the coating 270 in an amount of from about 10 to about 50 weight percent in alternate embodiments. The silicon compound within the coating 270 may be one or more partly hydrolyzed or entirely hydrolyzed silane. The silanes may be acyloxysilanes, alkylsilanes, alkyltrialkoxysilanes, aminosilanes, aminoalkylsilanes, aminopropyltrialkoxysilanes, bis silyl silane, epoxisilanes, allylsilanes, fluoralkylsilanes, glycidoxysilanes, isocyanatosilane, mercaptosilanes, arclsilanes, monosilylsilane, multisilylsilanes, bis(trialkoxysilylpropyl)amine, bis(trialkoxysilyl)ethane, sulfur containing silanes, ureidosilanes (for example 3-ureidopropyl-triethoxysilane and vinylsilanes), or other silane compounds. The coating 270 may also include, as an alternative or in supplement to the silane, at least one siloxane corresponding to the above-mentioned silanes, so the silicon compound may be selected from the group of silanes, siloxanes, and combinations thereof in some embodiments. In some embodiments the silane and/or siloxane has a chain-length in the range of 2 to 5 C atoms, and further includes a functional group that is suitable for reaction with the radiation curable crosslinking agent.

One or more inorganic components may also be present in the coating 270. The one or more inorganic components may facilitate certain aspects of the coating 270 that are beneficial for grain oriented electrical steel plates 200, such as improved corrosion resistance, color, mechanical stability of the coating, thermal conductivity, electrical properties, and thermal durability. In an exemplary embodiment, the inorganic component may be present in the coating 270 as a solution, a colloid, a dispersion, or in other forms. Exemplary inorganic components include, but are not limited to, carbonates, oxides, silicates, sulfates and sulfides. In the case of inorganic particles in particle form, the particle may include one or more of aluminum (Al), barium (Ba), cerium (Ce), calcium (Ca), lanthanum (La), silicon (Si), titanium (Ti), yttrium (Y), zinc (Zn) and zirconium (Zr). The inorganic compounds in particle form may have a mean particle size of from about 2 nanometers (nm) to 3,000 nm. Small particles having a particle size of from about 2 nm to about 250 nm may also be included as a stabilized dispersion or in the form of a sol or a gel. The coating 270 may optionally include the one or more inorganic compounds in an amount of from about 0 to about 60 weight percent, based on a total weight of the coating 270. In some embodiments, the coating 270 includes very little inorganic compounds, such as about 5 weight percent or less, based on the total weigh of the coating 270.

Inorganic compounds may be beneficial to adjust liquid properties of the coating 270, as well as cured protective layer properties. Examples for such inorganic compounds include oxides, phosphates, nitrates, silicates, carbonates, sulfates, and sulfides, but other types of compounds may also be included in the coating 270. For example, inorganic compounds or organic compounds with a metal may be present, where such compounds include one or more of the following elements; lithium (Li), sodium (Na), potassium (K), magnesium (Mg), aluminum (Al), Boron (B), bismuth (Bi), silicon (Si), selenium (Se), germanium (Ge), lanthanum (La), gallium (Ga), lead (Pb), tantalum (Ta), yttrium (Y), cerium (Ce), calcium (Ca), titanium (Ti), vanadium (V), iron (Fe), cobalt (Co), nickel (Ni), copper (Cu), zinc (Zn), zirconium (Zr), manganese (Mn), tin (Sn), molybdenum (Mo) and tungsten (W). Each element listed directly above may optionally be included in the coating 270 combined with one or more than one inorganic or organic moieties, and the coating may include zero, one, or more than one of the elements listed directly above. In this disclosure, a component, moiety, or element may be considered absent from the coating 270 if it is present in an amount of from 0 to about 100 ppm, unless otherwise specified. In an exemplary embodiment, the coating 270 is free of chromium (Cr), such that Cr is present in the coating 270 in an amount of from 0 to about 100 ppm (0 to about 0.01 weight percent, based on the total weight of the coating 270).

It may also be beneficial to include a wide variety of additives within the coating 270. The additives may be included to adjust substrate wetting, surface characteristics, rheology, viscosity, color, or a wide variety of other coating properties, either in a liquid state as applied or in a solid state after curing. Additives that may be included in the coating 270 include, but are not limited to, defoaming agents, dispersing agents, wetting agents, flatting agents, antibacterial agents, thickening agents, coloring agents, etc. Zero, one, or more than one additive may be included in the coating 270.

The coating 270 may also include zero, one, or more than one non-reactive components, where the non-reactive components may be present in the coating 270 in an amount of from about 0 to about 60 weight percent, based on the total weight of the coating 270. Non-reactive components mean all compounds used to adjust a property of the coating 270 that, under customary application conditions, do not participate in a chemical reaction or only participate in a chemical reaction to a negligible extent, such as less than 0.1 weight percent of the component participates in a chemical reaction, based on a total weight of that component. Examples of non-reactive components include, but are not limited to, nonpolar diluents, polar aprotic diluents, and polar protic diluents. A few examples of non-reactive nonpolar diluents include alkanes, cycloalkanes, heterocyclic compounds, aromatic compounds, ethers, esters, and some halogenated species. Examples for polar aprotic diluents include, but are not limited to, propylene carbonate, acetone, ethyl acetate, tetrahydrofuran, compounds comprising hetero atoms like dimethyl formamide, dimethyl sulfoxide, acetonitrile, nitromethane, and many others. Exemplary protic diluents include water, alcohols, poly alcohols, organic acids, other compounds with one or more hydroxyl groups, and others.

After the coating 270 is applied, the coating 270 is irradiated and cured 100, as illustrated in FIG. 1 with continuing reference to FIG. 2. The coating is cured on the plate 200 by irradiation using a radiation source 340, where the radiation source may be an electron beam or a source of electromagnetic radiation. The coating 270 may be cured in a curing unit equipped with the radiation source. Examples of radiation sources that may be utilized in various embodiments include an ultraviolet radiation source such as light-emitting diodes (LEDs), xenon lamps, mercury lamps or other arc lamps that may or may not be partially doped. In another embodiment, the radiation source is an electron beam source such as a beta ray generator. A gamma ray generator may also be utilized in alternate embodiments. It is also possible to utilize a combination of the radiation sources. A variety of atmospheres may be utilized in the curing unit. Air is one possible atmosphere, but other atmospheres may be desirable in some embodiments, such as nitrogen, argon, zenon, helium, carbon dioxide, hydrogen, other inter gases, or combinations of the same.

In some embodiments, the plate 200 is coated and cured on a production line 280, as illustrated in FIG. 3 with continuing reference to FIGS. 1 and 2. FIG. 3 is a diagram that illustrates the general concepts of the production line, but specific details are omitted or simplified for clarity. The production line 280 includes transfer rollers 290 used to facilitate transfer the plate 200 from one production process to the next. In the embodiment in FIG. 3, the recrystallization annealing process 80, the coating process 90, and the curing process 100 as shown in FIG. 1 are illustrated. The recrystallization annealing process 80 is performed in a recrystallization oven 300, where the recrystallization oven 300 includes a heating component 312. The plate 200 is transferred along the production line 280 from the recrystallization oven 300 to a coating station 310, where the coating station 310 includes a coating roller 320 in the embodiment illustrated in FIG. 3. The plate 200 is then transferred along the production line 280 from the coating station 310 to the curing station 330, where one or more radiation sources 340 are utilized to cure the coating 270 on the surface 230 of the plate 200. As such, the curing station 330 includes a radiation source 340. The transfer rollers 290 may be used to transfer the plate 200 from the recrystallization oven 300 to the coating station 310, and from the coating station 310 to the curing station, so the plate 200 is coated in the same production line and process used for recrystallization. Additional embodiments (not illustrated) are also possible, such as use of an air curtain for transferring the plate 200 from the coating station 310 to the curing station 330. Vertical transfer of the plate 200 from the coating station 310 to the curing station 330 is also possible, as well as other embodiments.

An optional heat source 350 may be included in the curing station 330, where the addition of heat may speed the curing process. The heat source 350 may be an infrared emitter, a thermal heat source, or even a device used to recapture heat from another portion of the production line, such as from the recrystallization oven 300. The plate 200 may be coated soon after leaving the recrystallization oven 300, so the plate 200 may remain hot enough to accelerate the cure process after being coated in some embodiments. The plate 200 remains on the same production line 280 while being processed in each of (a) the recrystallization oven 300, (b) the coating station 310, and (c) the curing station 330, and while being transferred therebetween. As such, the manufacturing process for the grain oriented electrical steel plate 200 includes a coating station 310 and a curing station 330, so the final product exiting the production line includes a cured coating 270. The plate 200 may optionally be coiled after coating and curing of the coating.

The coating 270, which includes organic components, provides superior corrosion resistance, moisture resistance, and processing ability (such as remaining intact and adhered to the plate during cutting, stamping, or punching steps), as compared to a coating that does not include organic components, as mentioned above

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the application in any way. Rather, the foregoing detailed description will provide those skilled in the art with a convenient road map for implementing one or more embodiments, it being understood that various changes may be made in the function and arrangement of elements described in an exemplary embodiment without departing from the scope, as set forth in the appended claims.

What is claimed is:

1. A method for producing a steel plate, the method comprising the steps of:
forming molten steel comprising silicon at from about 2.5 to about 4.0 weight percent, carbon at from about 0.005 to about 0.1 weight percent, and iron at from about 90 to about 97.5 weight percent, all based on a total weight of the molten steel;
casting the molten steel into a slab;
cold rolling the slab into a plate, wherein the plate comprises a surface;
decarbonizing the plate using a decarbonization anneal at from about 850 to about 1,050 degrees Celsius (° C.);
recrystallizing the plate using a recrystallization anneal at from about 700 to about 1,300° C. to form grain oriented electrical steel;
applying a coating overlying the surface, wherein the coating comprises a radiation curable crosslinking agent that is organic, and the coating comprises a photo-initiator; and
curing the coating on the surface of the plate by exposing the coating to a radiation source.

2. The method of claim 1, wherein curing the coating comprises exposing the coating to an electron beam, a source of electromagnetic radiation, or a combination thereof.

3. The method of claim 1, wherein applying the coating comprises applying the coating comprising a silane at from about 0 to about 50 weight percent, based on a total weight of the coating.

4. The method of claim 1, wherein applying the coating comprises applying the coating comprising inorganic particulates at from about 0 to about 60 weight percent, based on a total weight of the coating.

5. The method of claim 4 wherein applying the coating comprises applying the coating wherein the inorganic particulates are selected from the group of carbonates, oxides, silicates, sulfates, sulfides, and combinations thereof, and wherein the inorganic particulates further comprise one or more of aluminum (Al), barium (Ba), cerium (Ce), calcium (Ca), lanthanum (La), silicon (Si), titanium (Ti), yttrium (Y), zinc (Zn), and zirconium (Zr).

6. The method of claim 1 wherein applying the coating comprises applying the coating wherein the coating comprises one or more of the elements lithium (Li), sodium (Na), potassium (K), magnesium (Mg), aluminum (Al), Boron (B), bismuth (Bi), silicon (Si), selenium (Se), germanium (Ge), lanthanum (La), gallium (Ga), lead (Pb), tantalum (Ta), yttrium (Y), cerium (Ce), calcium (Ca), titanium (Ti), vanadium (V), iron (Fe), cobalt (Co), nickel (Ni), copper (Cu), zinc (Zn), zirconium (Zr), manganese (Mn), tin (Sn), molybdenum (Mo) and tungsten (W).

7. The method of claim 1 wherein applying the coating comprises applying the coating comprising the radiation curable crosslinking agent in an amount of from about 10 to about 90 weight percent, based on a total weight of the coating, and the photo-initiator in an amount of from about 0.1 to 20 weight percent, based on the total weight of the coating.

8. The method of claim 1, wherein applying the coating comprises applying the coating with a coating roller.

9. The method of claim 1, wherein:
recrystallizing the plate comprises recrystallizing the plate in a recrystallization oven; and
applying the coating comprises applying the coating in a coating station;
the method further comprising transferring the plate from the recrystallization oven to the coating station on transfer rollers.

10. The method of claim 1, wherein applying the coating comprises applying the coating wherein the radiation curable crosslinking agent is selected from the group of epoxy compounds, isocyanate compounds, polyurethane compounds, acrylic compounds, polyamide compounds, polyester compounds, silicone compounds and combinations thereof.

11. The method of claim 1, wherein applying the coating comprises applying the coating wherein the coating is about free of chromium, such that a chromium concentration in the coating is about 0.01 weight percent or less, based on a total weight of the coating.

12. The method of claim 1, wherein:
recrystallizing the plate comprises recrystallizing the plate on a production line, wherein the production line comprises transfer rollers configured for moving the plate; and
applying the coating comprises applying the coating on the production line.

13. The method of claim 12, further comprising:
moving the plate from a recrystallization oven to a coating station on the production line.

14. The method of claim 13, further comprising:
moving the plate from the coating station to a curing station on the production line, wherein the curing station comprises the radiation source.

15. The method of claim 1, wherein the coating comprises water in an amount of from about 20 to about 80 weight percent, based on a total weight of the coating.

16. A method for producing a grain oriented electrical steel plate, the method comprising the steps of:
producing a plate comprising electrical steel;
recrystallizing the plate in a recrystallization anneal at from about 700 to about 1,300 degrees Celsius to produce the grain oriented electrical steel, wherein the plate is recrystallized on a production line comprising transfer rollers;
applying a coating to a surface of the plate while the plate is on the production line, wherein the coating comprises organic components; and
curing the coating on the surface of the plate by exposing the coating to a radiation source, wherein the plate is cured while on the production line.

17. The method of claim 16, further comprising:
moving the plate from a recrystallization oven to a coating station on the production line; and
moving the plate from the coating station to a curing station on the production line.

18. The method of claim 16, wherein applying the coating comprises applying the coating wherein the coating comprises a radiation curable crosslinking agent at from about 5 to about 90 weight percent, wherein the radiation curable crosslinking agent is organic, and wherein the coating comprises a photo-initiator at from about 0.1 to about 20 weight percent, based on a total weight of the coating.

19. The method of claim 18, wherein applying the coating comprises applying the coating wherein the coating comprises a silicon compound, wherein the silicon compound is selected from a silane, a siloxane, or a combination thereof.

20. A grain oriented electrical steel plate, comprising:
a surface of the grain oriented electrical steel plate;
a forsterite layer at the surface of the grain oriented electrical steel plate;
a coating overlying the surface, wherein the coating comprises organic components at from about 10 to about 99 weight percent, based on a total weight of the coating, and wherein the organic components comprise polymers formed from radiation curable crosslinking agents; wherein
the grain oriented electrical steel comprises carbon at from about 0.01 to about 0.03 weight percent, based on a total weight of the grain oriented electrical steel, and silicon at from about 2.5 to about 4.0 weight percent, based on the total weight of the grain oriented electrical steel; and
wherein the grain oriented electrical steel plate comprises a grain oriented electrical steel with anisotropic magnetic properties such that a plate magnetic permeability in a roll direction is greater than the plate magnetic permeability in a cross direction, where the cross direction is perpendicular to the roll direction.
